(19) United States
(12) Patent Application Publication
(10) Pub. No.: US 2011/0104473 A1
(43) Pub. Date: May 5, 2011

(54) LIGHT WEIGHT INTERPENETRATING PHASE COMPOSITE FOAM AND METHODS FOR MAKING AND USING THE SAME

(76) Inventors: Hareesh V. Tippur, Auburn, AL (US); Rahul Jhaver, Vicksburg, MS (US)

(21) Appl. No.: 12/789,508

(22) Filed: May 28, 2010

Related U.S. Application Data
(60) Provisional application No. 61/217,548, filed on Jun. 1, 2009.

(51) Int. Cl. B32B 3/26; B05D 3/10

(52) U.S. Cl. 428/319.1; 427/322

(57) ABSTRACT

The present invention is directed to the composition for and methods of processing composite structural foam. In one embodiment, a method of producing a Interpenetrating Phase Composite (IPC) foam is disclosed. In this method, uncured epoxy-based syntactic foam is prepared and infiltrated into an open-cell scaffold. In some embodiments, the uncured epoxy-based syntactic foam contains premixed micron-size hollow glass microballoons. In other embodiments, the scaffold is coated with a silane. The uncured epoxy-based syntactic foam is subsequently cured to produce the Interpenetrating Phase Composite (IPC) foam.

### CROSS REFERENCE TO RELATED APPLICATIONS

This application claims priority to U.S. Provisional Patent Application Ser. No. 61/217,548, filed Jun. 1, 2009, which is hereby incorporated herein by reference for all purposes.

### ACKNOWLEDGEMENTS

The research leading to this invention was funded in part by the U.S. Army Research Office, Grant No. W911 NF-08-1-0285. The U.S. Government has certain rights in this invention.

### BACKGROUND OF THE INVENTION

Foams are used in a variety of structural applications for their good compression response and mechanical energy dissipation characteristics while keeping the overall structural weight to a minimum. They are also known for offering good thermal and acoustic insulation. A class of structural foams called syntactic foams is considered for structural applications. These foams can be distinguished from conventional variety by the way they are manufactured. Unlike traditional foams which are produced by gasification of the matrix material, syntactic foams are produced by mechanical blending of hollow polymer, ceramic or metal microballoons (hollow microspheres) in a polymer or metal matrix. Thus porosity is due to the ‘filler’ phase resulting in a closed-cell microstructure. Further distinction of these foams is that porosity in these materials is often microscopic and known to offer many advantages including high surface area to volume ratio as well as macroscopic isotropy. The range of engineering applications of these foams has increased in recent years due to the advancement of materials processing methods that offer choices in microballoon wall-thickness and diameter as well as the materials with which they are made of. Syntactic foams have been extensively used by naval and marine equipment manufacturers for decks and submarines buoys. Syntactic foams are also used in civil and industrial engineering as imitation wood and other building construction materials for their high hear stiffness and specific strength. Due to the high specific energy absorption and impact resistance, syntactic foams have the potential for use as core materials of sandwich structures in lightweight combat vehicles and automobiles. Syntactic foams made of glass and carbon micro-/nano-spheres are used in aerospace structures, missile heads and heat shields for space vehicles. They are also employed in electronics and telecommunications due to superior thermal and dielectric properties as well as shock absorption characteristics.

Continued demand for lighter, stiffer, stronger and tougher structural components requires development of novel materials. Heterogeneous materials with discrete, dispersed and/or embedded phases in a matrix material (fiber reinforced composites, particulate composites, functionally graded materials, syntactic foams, etc.) are found suitable for many structural applications. There are, however, limitations in terms of the degree of concentration of the secondary phase that can be dispersed into the primary phase and the degree of inter connectivity between the phases. Nature overcomes such a limitation by adopting 3-D interpenetrating microstructures as evident in skeletal tissue and botanical systems. This observation has inspired a relatively new category of materials called Interpenetrating Phase Composite/s or IPC (also referred to as co-continuous composites. The IPC are multiphase materials in which the constituent phases are interconnected three-dimensionally and topologically throughout the microstructure (and hence sometimes are referred to as “3-3” composites). That is, both matrix and reinforcement phases/s interpenetrate all over the microstructure in all the three spatial dimensions. Thereby the two constituents in their stand alone state would have an open cell microstructure. Hence, IPC are uniquely different from traditional composites comprising of a matrix with one or more reinforcing filler phases (long fibers, whiskers, particles, microballoons, etc.) where such a complete interpenetration does not occur. Consequently, each phase of an IPC contributes its property to the overall macro scale characteristics synergistically. For example, if one constituent provides strength and toughness, the other might enhance stiffness, thermal stability, acoustic insulation and/or dielectric characteristics. Additionally, it is also possible to tailor residual stresses in the constituents to produce advantageous macro scale response in a metal-ceramic IPC. The tensile residual stresses in the metallic phase and the compressive ones in the ceramic phase delay crack initiation and strengthen the IPC. Based on the occurrence of phase interpenetration of different length scales, interpenetrating phase composites can be classified as molecular, micro or meso varieties. A blend of two or more cross-linked polymers which are interlaced but not covalently bonded to each other and cannot be separated unless chemical bonds are broken is an example of a molecular scale IPC and is called an InterPenetrating Network (IPN).

### SUMMARY OF THE INVENTION

The present invention is directed to the composition for and methods of processing composite structural foam. In one embodiment, a method of producing a Interpenetrating Phase Composite (IPC) foam is disclosed. In this method, uncured epoxy-based syntactic foam is prepared and infiltrated into an open-cell scaffold. In some embodiments, the uncured epoxy-based syntactic foam contains premixed micron-size hollow glass microballoons. In other embodiments, the scaffold is coated with a silane. The uncured epoxy-based syntactic foam is subsequently cured to produce the Interpenetrating Phase Composite (IPC) foam.

The advantages of the invention will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

FIG. 1 is a perspective view of an interpenetrating phase composite (IPC) foam according to an example embodiment of the present invention.

FIG. 2 is a microscopic close-up view of a cross-section of the IPC foam of FIG. 1.

FIG. 3 is a micrograph of example epoxy syntactic foam having a 30% volume fraction of hollow glass microballoons.

FIG. 4a is a cross-section of a lightweight IPC foam cylinder according to an example embodiment of the present invention having an open-cell aluminum preform infiltrated with epoxy based syntactic foam.

FIG. 4b is a micrograph of the IPC foam of FIG. 4a.

FIG. 5a is a chart showing the stress-strain curves of example syntactic foam having a volume fraction of 20% of microballoons for multiple aspect ratios.

FIG. 5b is a chart showing the stress-strain curves of example syntactic foam having a volume fraction of 20% of microballoons and having a length to diameter ratio of 0.74.

FIG. 6 is a chart showing the stress-strain curves of example syntactic foams having volume fractions of microballoons at 20%, 30% and 40%.

FIG. 7a is a SEM image of an example deformed syntactic foam sample with 30% volume fraction of microballoons at a strain of about 10%.

FIG. 7b is a SEM image of an example deformed syntactic foam sample with 30% volume fraction of microballoons at a strain of about 60%.

FIG. 7c is a SEM image of the highlighted portion of FIG. 7b.

FIG. 8a is a chart demonstrating the compression response of example uncoated IPC foams with varying microballoon volume fractions and example unfilled aluminum preforms.

FIG. 8b is a chart demonstrating the compression response of example silane coated IPC foams with varying microballoon volume fractions.

FIG. 9a is a SEM image of an example silane coated IPC foam at a strain of 10%.

FIG. 9b is a SEM image of an example silane coated IPC foam at a strain of 58%.

FIG. 9c is a SEM image of an example uncoated IPC foam at a strain of 14%.

FIG. 10a is a chart demonstrating the comparison of stress-strain response of syntactic foam examples, IPC foam examples with uncoated preform, and IPC foam examples with silane coated preform for 20% volume fraction of microballoons.

FIG. 10b is a chart demonstrating the comparison of stress-strain response of syntactic foam examples, IPC foam examples with uncoated preform, and IPC foam examples with silane coated preform for 30% volume fraction of microballoons.

FIG. 10c is a chart demonstrating the comparison of stress-strain response of syntactic foam examples, IPC foam examples with uncoated preform, and IPC foam examples with silane coated preform for 40% volume fraction of microballoons.

FIG. 11a is a chart showing the comparison of energy absorption (up to 50% strain) for syntactic foams and IPC foam samples per unit volume.

FIG. 11b is a chart showing the comparison of energy absorption (up to 50% strain) for syntactic foams and IPC foam samples per unit mass.

### DETAILED DESCRIPTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Described herein are Interpenetrating Phase Composite (IPC) foams and methods for making and using the same. As described above, the Interpenetrating Phase Composite (IPC) foams described herein (also called co-continuous composites) are multiphase materials in which the constituent phases are interconnected three-dimensionally and topologically throughout the microstructure (and hence sometimes are referred to as “3-3” composites). That is, both matrix and reinforcement phase/s interpenetrate all over the microstructure in all the three spatial dimensions. In one embodiment, the IPCs are meso-/micro-scale IPCs.

In one embodiment, the Interpenetrating Phase Composite (IPC) is produced by the method comprising:

a. providing an uncured epoxy-based syntactic foam;
b. infiltrating the uncured epoxy-based syntactic foam into an open-cell scaffold; and
c. curing the uncured epoxy-based syntactic foam to produce the Interpenetrating Phase Composite.

In another embodiment, the Interpenetrating Phase Composite comprises:

a. a scaffold; and
b. a cured epoxy-based syntactic foam in contact with the scaffold.

Each component and step listed above is described in detail below. The syntactic foams useful herein are produced from uncured epoxy-based resins. The epoxy resin can vary and includes conventional, commercially available epoxy resins. Two or more epoxy resins may be employed in combination. In one embodiment, the epoxy resins can be glycidated resins, cycloaliphatic resins, epoxidized oils, and so forth. In one aspect, the glycidated resins are the reaction product of a glycidyl ether, such as epichlorohydrin, and a bisphenol compound such as bisphenol A. C₄-C₂₈ alkyl glycidyl ethers; C₂-C₂₈ alkyl- and alkenyl-glycidyl esters; C₁-C₂₈ alkyl-, mono- and poly-phenol glycidyl ethers; polyglycidyl ethers of pyrocatechol, resorcinol, hydroquinone, 4,4′-dihydroxydiphenyl methane (or bisphenol F), 4,4′-dihydroxy-3,3′-dimethyldiphenyl methane, 4,4′-dihydroxydiphenyl dimethyl methane (or bisphenol A), 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, and tris (4-hydroxyphynyl)methane; polyglycidyl ethers of the chlorination and bromination products of the above-mentioned diphenols; polyglycidyl ethers of novolacs; polyglycidyl ethers of diphenols obtained by esterifying ethers of diphenols obtained by esterifying salts of an aromatic hydrocarboxylic acid with a dihaloalkane or dihalogen dialkyl ether; polyglycidyl ethers of polyphenols obtained by condensing phenols and long-chain halogen paraffins containing at least two halogen atoms; N,N′-diglycidyl-aniline; N,N′-dimethyl-N,N′-diglycidyl-4,4′-diaminodiphenyl methane; N,N,N′,N′-tetraglycidyl-4,4′-diaminodiphenyl methane; N,N′-diglycidyl-4-aminophenyl glycidyl ether; N,N,N′,N′-tetraglycidyl-1,3-propylene bis-4-aminobenzoate; phenol novolac epoxy resin; cresol novolac epoxy resin; and combinations thereof. In one aspect, the epoxy resin is Epo-Thin manufactured by Buehler, Ltd., which is a bisphenol-A-(epichlorhydrin) epoxy resin.

In certain embodiments, a curing agent can be used to produce the syntactic foam. The selection of a given curing agent is dependent on the size of the syntactic foam batch to be cured and the reactivity of a given curing agent. In one aspect, an amine curing agent can be employed. Various polyamines can be used for this purpose, including aliphatic and aromatic amines, cycloaliphatic amines, a Lewis base or a Mannich base. For example, the aliphatic amine and cycloaliphatic amines may be alkylene diamines such as ethylene diamine, propylene diamine, 1,4-diaminobutane, 1,3-diaminopentane, 1,6-diaminohexane, 2,5-diamino-2,5-dimethylhexane, 2,2,4-trimethyl-1,6-diaminohexane, 1,11-diaminoundecane, 1,12-diaminododecane, 1,3- or 1,4-cyclohexane diamine, 1-amino-3,3,5-trimethyl-5-aminomethyl-cyclohexane, 2,4- or 2,6-hexahydrotolvylene diamine 2,4′- or 4,4′-diaminodicyclohexyl methane, 3,3′-dialkyl-4,4′-diamino-dicyclohexyl methane isophoronediamine, trimethylhexamethylene diamine, triethylene diamine, piperazine-n-ethylamine, polyoxyalkylene diamines made from propylene oxide and/or ethylene oxide. Examples of aromatic polyamines include 2,4- or 2,6-diaminotoluene and 2,4′- or 4,4′-diaminodiphenyl methane. Mixtures of amine curing agents can also be used herein.

In certain embodiments, the uncured epoxy-based syntactic foam comprises premixed micron-size hollow microballoons (also referred to as microbubbles or microspheres). The microballoons can be made of a variety of materials including, but not limited to, glass and ceramics. In other aspects, the microballoons are polymeric microspheres. For example, the microsphere can be Expancel manufactured by AkzoNobel. In another aspect, the microballoon is a sodium-lime-borosilicate glass sold under the tradename K-1 by 3M Corp. Other examples of commercially available glass microballoons useful herein include S15/300, B38, C15, K20, VS 5500, A16, H2O and the like, which are available from 3 M. In one embodiment, the microballoons have a mean diameter of about 50-70 micrometers and wall thickness of about 0.5-0.7 micrometers. In another embodiment, the volume fraction of microballoons in the syntactic foam is from 10%-50% while keeping the volume fraction of the metallic scaffold the same in order to produce different IPC foam varieties.

The open-cell scaffold can be composed of a variety of different metals. In one embodiment, the scaffold is composed of a metal or metal oxide. For example, the scaffold is composed of aluminum, copper, nickel. In one embodiment, metallic scaffolds sold by ERG Aerospace, Inc. can be used herein. In other embodiments, the scaffolds are made of one or more polymeric materials. For example, the scaffold is composed of a tough polymeric material such as a urethane. In one embodiment, the scaffold has 30-50 pores per inch and about 8-10% relative density.

In certain embodiments, the scaffold can be coated with a silane in order to enhance adhesion of the uncured epoxy-based syntactic foam to the scaffold. In one embodiment, the silane comprises a straight or branched-chain aminosilane, aminoalkoxysilane, aminoalkylsilane, aminoarylsilane, an aminoaryloxysilane, or any combination thereof. In another embodiment, the silane comprises gamma-aminopropyl trimethoxysilane, N-(beta-aminoethyl)-3-aminopropyl trimethoxysilane, N-(beta-aminoethyl)-3-aminopropyl triethoxysilane, N′-(beta-aminoethyl)-3-aminopropyl methoxysilane, or aminopropylsilsesquixoane.

After applying the uncured epoxy-based syntactic foam to the scaffold, the uncured epoxy-based syntactic foam is cured to produce the Interpenetrating Phase Composite foam. In one embodiment, the foam is cured at room temperature and atmospheric temperature. By varying the temperature, it is possible to cure the uncured epoxy-based syntactic foam at an increased rate.

In certain embodiment, molds can be used to produce the Interpenetrating Phase Composite in a variety of different shapes and sizes. In one embodiment, the method involves:

a. pouring the uncured the epoxy-based syntactic foam into a mold;
b. inserting the open-cell scaffold into the mold containing the uncured epoxy-based syntactic foam; and
c. curing the uncured epoxy-based syntactic foam to produce the Interpenetrating Phase Composite.

Exemplary procedures for making the Interpenetrating Phase Composites described herein using molds are provided in the Examples.

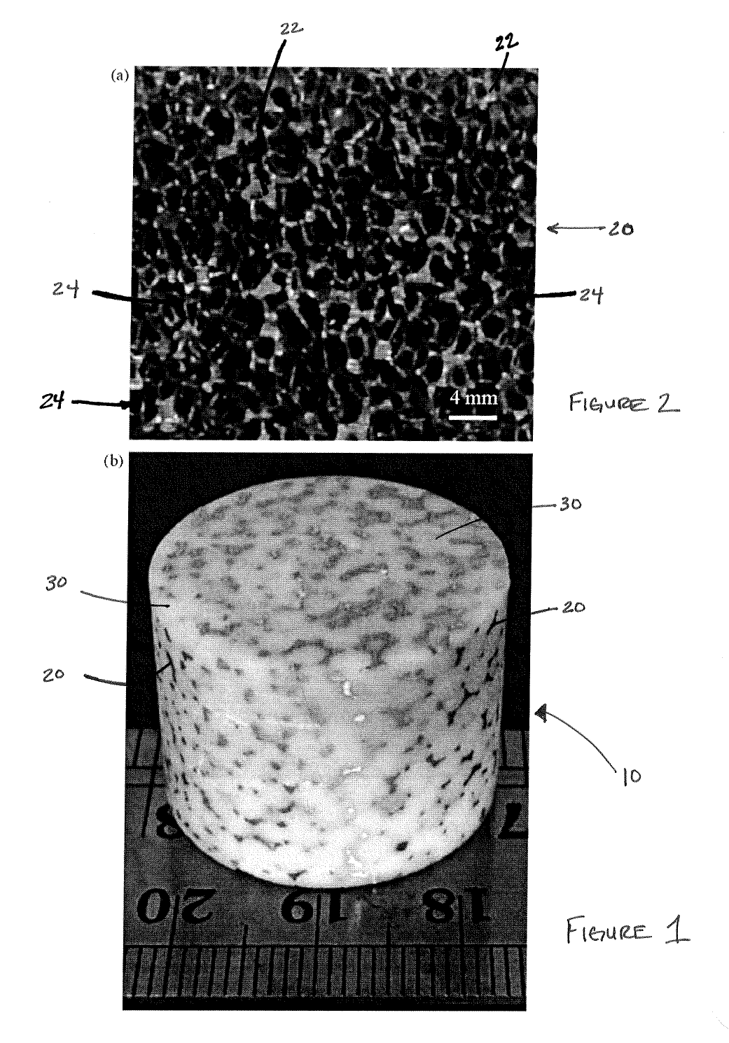

With reference now to the drawing figures, wherein like reference numbers represent corresponding parts throughout the several views, specific embodiments of the invention are described below. FIG. 1 shows an interpenetrating phase composite (“IPC”) foam 10 according to an example embodiment of the present invention. The IPC foam 10 depicted in FIG. 1 is generally comprised of a three-dimensional open-cell metallic foam scaffolding or network 20 that has been infiltrated with a syntactic foam 30. The compression response of syntactic foams can be enhanced by infiltrating a syntactic foam into lightweight open-cell preforms or scaffolding made of a stronger and tougher material, such as the open-cell metallic foam 20 shown in FIG. 1. The resulting IPC foam exhibited improved mechanical characteristics (e.g. in tension and shear) as compared to conventional polymer syntactic foams as will be discussed in detail below.

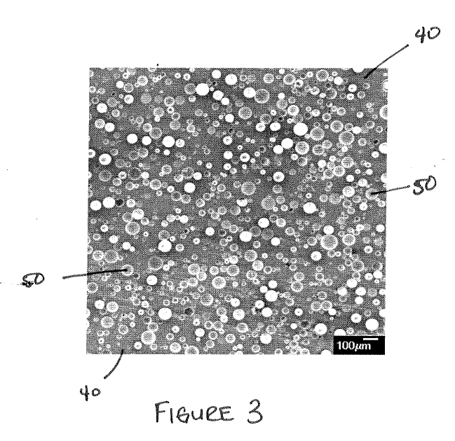

In particular, example embodiments of IPC foam according to the present invention (such at the IPC foam depicted in FIG. 1) can be produced by the following process steps. First, a mold is obtained or prepared having dimensions as desired by a user. In depicted embodiments, Applicants utilized a silicone rubber mold with a blind cylindrical well having dimensions that mirror the desired final IPC foam dimensions, however, in alternative embodiments molds formed from plastic, silicone, rubber or other materials can be utilized as desired by a user. Next, uncured liquid syntactic foam is poured into the mold just before the syntactic foam begins to gel. Subsequently, a cylindrical aluminum preform or network (such as the open-cell metallic foam 20 of FIG. 1) is lowered into the mold bearing the liquid syntactic foam using a pressureless infiltration technique. It has been found that the lowering of the metallic foam into the liquid syntactic foam ensures good percolation of the uncured syntactic foam into all the cells of the metallic preform. Optionally, the metallic foam can first be placed into the mold before the liquid syntactic foam is poured into the same. While many different types of metallic foam can be used in conjunction with the present invention, example embodiments utilized commercially available open-cell aluminum foam (made of AL 6101-T6; pore density=about 40 pores per inch, relative density=about 9% (optionally between about 8% to about 10%), manufactured by ERG Inc., USA) as the scaffold for the IPC foam. In other embodiments, the metallic foam can have between about 30 to about 50 pores per inch—and still further between about 20 to about 60 pores per inch. As seen in FIG. 2, which shows aluminum cell walls 22 and hollow cell volumes 24, example metallic preforms 20 have a uniform cell size distribution resulting in an isotropic mechanical response at macro scales. In the final step of the process, the resulting IPC foam is permitted to cure before removing the mixture from the mold. In example embodiments, the resulting IPC foam was permitted to cure at room temperature for 48 hours before removing the foam from the mold, however, cure times can fluctuate widely depending on many factors such as size of the mold, cure temperature, type of syntactic foam used, etc.

The metallic preforms can be utilized “as-is” from commercial suppliers or can be degreased with laboratory grade alcohol before being inserted into the liquid syntactic foam. Optionally, a degreased metallic preform can be coated with amino silane, γ-aminopropyltrimethoxysilane (H₂C₂H₄NHC₃H₆Si(OCH₃)₃) to enhance adhesion between syntactic foam/epoxy and the metallic ligaments of the scaffolding/network/preforms. The adhesion between the metallic preform and syntactic foam is substantially stronger when the preform is pre-coated with amino silane (or other adhesion enhancers as desired by a user) than when the preform is used “as-is” or is merely degreased prior to be introduced to the liquid syntactic foam.

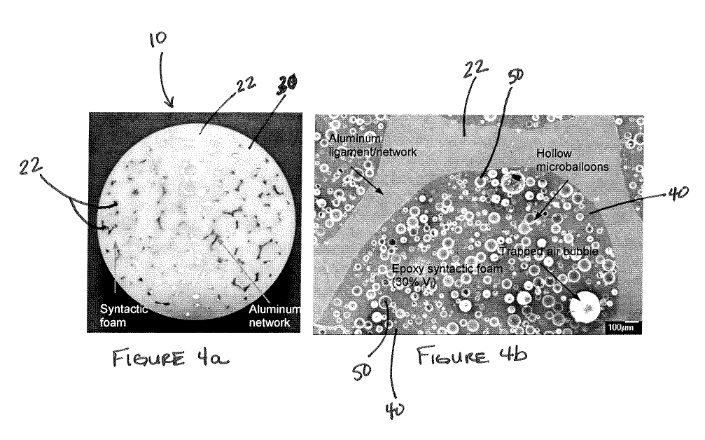

While numerous types of syntactic foams can be incorporated into IPC foams according to the present invention, epoxy-based syntactic foams containing different volume fractions of hollow soda-lime glass microballoons are typically utilized as shown in FIG. 3, which depicts a liquid epoxy resin 40 mixed with soda-lime microballoons 50 (30% by volume). Indeed, in example embodiments, epoxy-based syntactic foams having volume fractions of between about 10% to about 50% of hollow soda-lime glass, and more particularly about 20% to about 40% of hollow soda-lime glass are utilized and are typically prepared by the following method. First, the epoxy resin is heated to 50° C. for about 45 minutes. Predetermined amount of microballoons (typically spherical hollow balloons having a mean diameter of about 60 μm and wall thickness of about 600 nm) are added into the epoxy resin and the mixture is carefully stirred ensuring uniform distribution of the filler. Alternatively, microballoons having a mean diameter of between about 50 micrometers and about 70 micrometers, and a wall thickness of between about 0.5 micrometers and about 0.7 micrometers can be used. Subsequently, an amine based curing agent is introduced and stirring is continued. The mixture is then placed in a vacuum chamber and evacuated. In example embodiments, the vacuum chamber was evacuated down to −75 kPa (gage) pressure. Once this pressure is reached (or other pressure(s) as desired by a user) the vacuum is released and the chamber is returned to atmospheric condition. This process is generally repeated (about 8-10 times) until no air bubbles are observed in the mixture. Alternatively, the vacuum can be run for a continuous set period of time as desired by a user. When the mixture shows a tendency to gel, it is transferred into a mold (typically a silicone rubber mold with a blind cylindrical cavity). It has been discovered that the increased viscosity of the mixture prevented segregation of microballoons due to buoyancy forces.

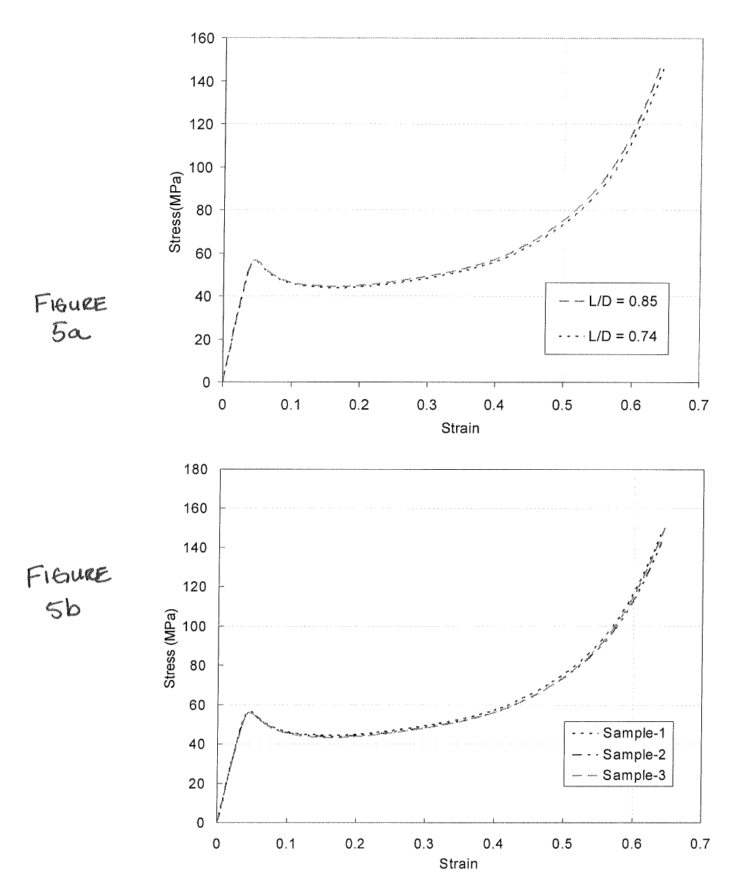

SEM images showing polished surfaces of example embodiments of syntactic foam and IPC foam with 30% volume fraction of microballoons are seen in FIGS. 3 & 4 (4a/4b), respectively. FIG. 3 shows random but uniform distribution of microballoons 50 in the epoxy matrix 40. From the micrograph it can also be seen that microballoons 50 show a relatively broad size variation. The cross-section of cast cylindrical IPC foam 10 so obtained is shown in FIG. 4a. The photograph reveals aluminum cell walls 22 (shiny gray ligaments) interconnecting pockets (white) of syntactic foam 30 throughout. A micrograph of an undeformed IPC foam specimen obtained using a scanning electron microscope is shown in FIG. 4b. It clearly shows aluminum ligaments or cell walls 22 surrounded by microballoons 50 dispersed in the epoxy matrix 40. From FIGS. 4a and 4b, it can be seen that the metal-polymer foam interfaces are crisp and continuous suggesting a good bond between the two. Indeed, the microstructure does not show any evidence of distortions in the aluminum ligaments 22 caused by the curing process.

The Interpenetrating Phase Composites described herein can be used in a number of different applications. In one embodiment, the composites can be in any article where it is desirable to absorb energy. In certain embodiments, the composites can be used as lightweight energy absorbing structural materials or core materials in sandwich structures used in aircraft structures, high-speed trains, automobiles as well as marine structures and submersibles.

### Examples

The following examples are put forth so as to provide those of ordinary skill in the art with a complete disclosure and description of how the compounds, compositions, and methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

### Material Preparation

### Syntactic Foam Preparation

Epoxy-based syntactic foams containing different volume fractions (20%, 30% and 40%) of hollow soda-lime glass microballoons were processed. The method involved heating epoxy resin to 50° C. for approximately 45 min. Predetermined amount of microballoons (spherical hollow balloons of mean diameter approximately 60 μm and wall-thickness approximately 600 nm) were added into epoxy resin and the mixture was carefully stirred ensuring uniform distribution of the filler. Subsequently, an amine based curing agent was introduced and stirring was continued. The mixture was then placed in a vacuum chamber and evacuated down to −75 kPa (gage) pressure. Once this pressure was reached the vacuum was released and the chamber was returned to atmospheric condition. This process was repeated (about 8-10 times) until no air bubbles were observed in the mixture. (This method of cyclic vacuuming of the mixture was found to be more effective when compared to holding the vacuum continuously for a set period of time.) When the mixture showed a tendency to gel, it was transferred into a silicone rubber mold with a blind cylindrical cavity. The increased viscosity of the mixture prevented segregation of microballoons due to buoyancy forces. The mixture was then cured at room temperature for a period of 48 h and rested for over a week to obtain a macroscopically homogeneous and isotropic solid. The cylindrical sample was then machined to the required dimensions. Unless specified otherwise, in this work, the sample length and diameter were 20 mm and 26.7 mm, respectively.

### IPC Foam Preparation

The pressureless infiltration technique was used to produce the IPC foam. Commercially available open-cell aluminum foam (made of A16101-T6; pore density=40 ppi, relative density=9%, manufactured by ERG Inc., USA) was used as the scaffold for the IPC foam. The preform has a uniform cell size distribution resulting in an isotropic mechanical response at macro scales. The manufacturing of the IPC foam consisted of the following steps. A silicone rubber mold was first prepared with a blind cylindrical well of dimensions nearly close to the final sample dimensions. The syntactic foam (prepared as previously described) was then poured into the rubber mold just before the mixture started to gel. Subsequently a cylindrical aluminum preform of the required dimensions was slowly lowered into the cavity previously filled with uncured syntactic foam. This ensured good percolation of the uncured syntactic foam mixture into all the cells of the preform. The resulting IPC foam was then cured at room temperature for 48 hours before removing from the mold for machining. The cylindrical sample was subsequently machined to a length of 20 mm and diameter 26.7 mm.

Two different types of cylindrical IPC foam specimens were prepared. In the first type, the aluminum preform was used in ‘as-is’ state after degreasing it with laboratory grade alcohol. In the second type, the surface of the degreased aluminum preform was coated with amino silane, γ-aminopropyltrimethoxysilane (H₂C₂H₄NHC₃H₆Si(OCH₃)₃). This coating was to enhance adhesion between syntactic foam/epoxy and the aluminum ligaments whereas the former produced a weaker adhesion between polymer and metal phases of the IPC foam. Some of the relevant properties of different phases of the IPC foam are listed in Table 1.

TABLE 1
Properties of constituents

| Properties | Neat Epoxy¹ | Microballoons² |
|---|---|---|
| Elastic Modulus (MPa) | 3200 | — |
| Bulk Density (kg/m³) | 1175 | 125 |
| Poisson's ratio | 0.34 | — |

¹supplied by Buehler, Inc., under the trade name ‘Epo-Thin’
²supplied by 3M Corp., under the trade name K-1 microballoons

### Tests and Results

A series of compression tests were carried out by the Applicants on syntactic and IPC foam specimens at room temperature using a MTS universal testing machine fitted with a 100 kN load cell. The tests were performed according to ASTM standard D-695 for plastics. A cross-head speed of 1.25 mm/min was used during the tests done in displacement control mode. Dry graphite powder was used as a lubricant between the platens and the specimen surfaces to minimize friction.

### Syntactic Foams

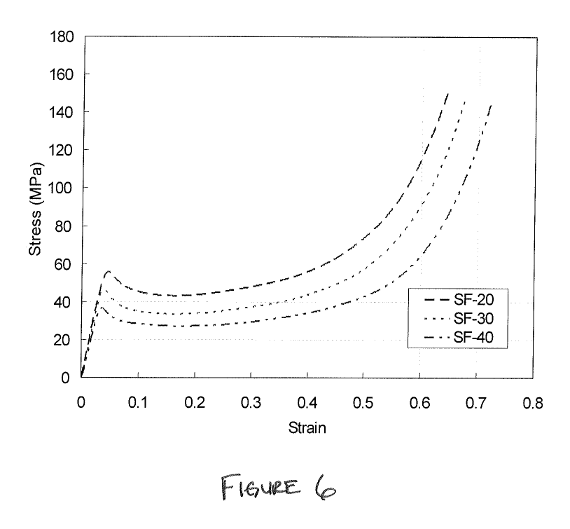

First, uniaxial compression tests were performed on syntactic foam samples of two different specimen length (L) to diameter (D) ratios—0.74 and 0.85. (The aspect ratio was altered by changing the length of the specimen while keeping the specimen diameter same.) The measured engineering stress-strain responses for syntactic foam specimens with 20% microballoon volume fraction and two aspect ratios are shown in FIG. 5a. The two curves closely overlap on each other and are in close agreement. The values of elastic modulus in each case is 1594±50 MPa and compressive yield stress is 55.7±2 MPa. The results being nearly the same for both the cases, the effect of the two L/D ratios is insignificant for L/D<1 and hence in all subsequent tests a L/D ratio of 0.74 was used.

Next, the repeatability of compressive stress-strain responses of syntactic foam samples was studied. FIG. 5b shows engineering stress-strain curves for three different samples made from 20% volume fraction of microballoons in epoxy resin. Good repeatability is evident from FIG. 5b. (Similar tests for two other volume fractions namely 30% and 40% were also carried out and are not shown). In these curves a linear elastic response is seen initially. Upon yielding, the compressive stress decreases with increasing strain as evident from the softening response following the yield stress. This is followed by a plateau of nearly constant stress where progressive crushing of microballoons occurs. Further increase in load results in densification, as shown by the region of monotonically rising stress is consistent with known observations of syntactic foams and has many similarities with the compression response of structural foams in general.

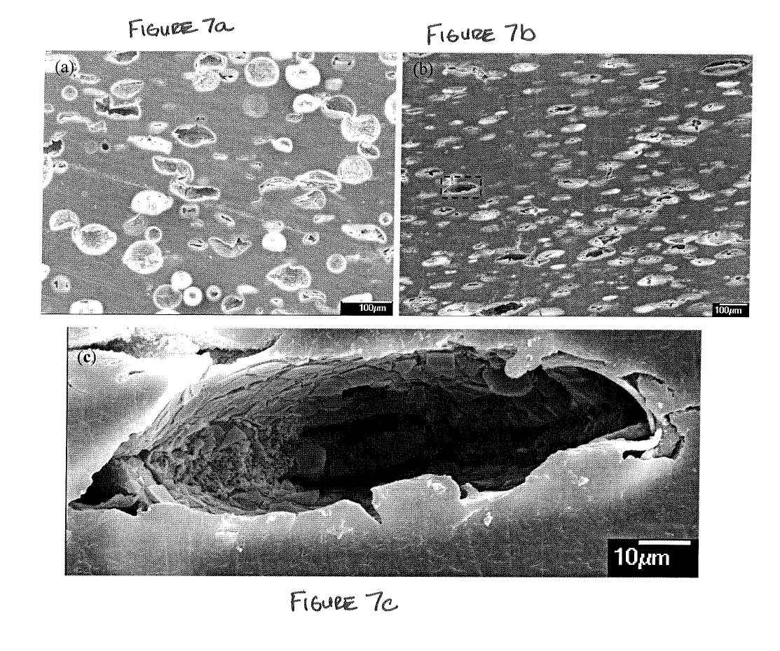

The influence of volume fraction (V_{f}) of microballoons on stress-strain response of syntactic foam was also studied. A few representative stress-strain responses for three volume fractions (20%, 30% and 40%) are shown in FIG. 6. An increase in volume fraction of microballons resulted in a reduction of elastic modulus as well as the compressive strength. For example, Table 2 catalogs these properties of various types of syntactic foam:

TABLE 2
Properties of syntactic foam

| | Volume fraction of | | Compressive | Elastic |
|---|---|---|---|---|
| Foam | microballoons | Density | strength | modulus |
| designation | (%) | (kg/m³) | (MPa) | (MPa) |
| SF-20 | 20 | 931 ± 4 | 55.7 ± 2.2 | 1594.7 ± 35 |
| SF-30 | 30 | 821 ± 6 | 46.3 ± 1.4 | 1447.6 ± 28 |
| SF-40 | 40 | 701 ± 4 | 36.7 ± 1.8 | 1260.5 ± 42 |

The elastic modulus and compressive strength decreased from 1595 MPa and 55.7 MPa, respectively for 20% volume fraction case to 1260 MPa and 36.7 MPa for 40% volume fraction case. The example foam samples SF-20 (V_{f}=20%), SF-30 (V_{f}=30%) and SF-40 (V_{f}=40%) show a linear elastic response up to strains of approximately 0.028, 0.031, 0.039, respectively. The plateau stress values in the three cases are 42 MPa, 33 MPa and 27 MPa for SF-20, SF-30 and SF-40, respectively. That is, the plateau stress decreases with increasing volume fraction of microballons. The onset of densification for the three cases is in the strain range of 0.3-0.5 with the lower value corresponding to the lower volume fraction of microballoons. Beyond this strain, stress increases with increasing strain. All specimens showed formation of inclined cracks at advanced stages of loading suggesting shear localization. This is consistent with previously known properties for syntactic foams.

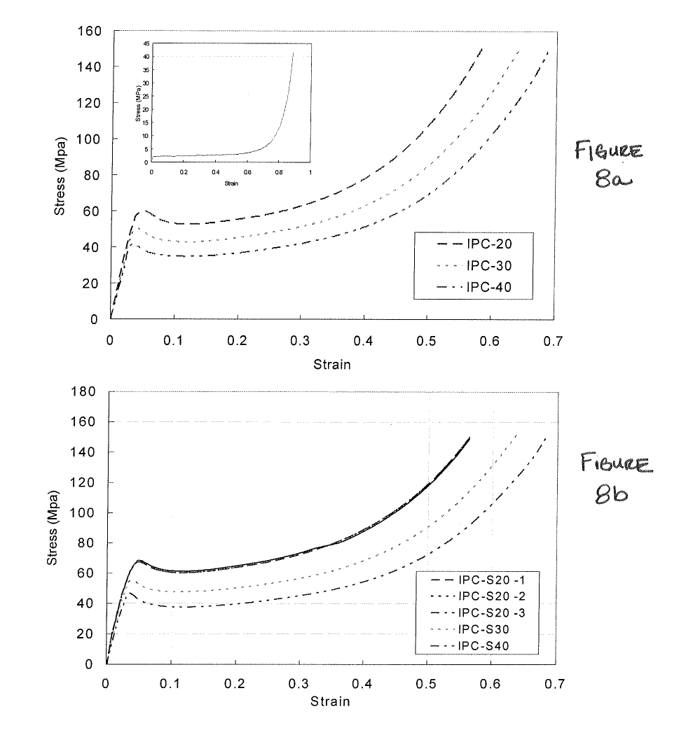

In order to explain the failure behavior of syntactic foams, deformed specimens were sectioned and microscopically examined at a few select strain levels. FIGS. 7a, 7b, & 7c show SEM images of a syntactic foam sample (with 30% volume fraction of microballoons). In these figures it can be seen that the direction of compression is along the vertical axis. For instance FIGS. 7a & 7b depict micrographs of deformed specimens at 10% and 60% strain. FIG. 7c depicts an enlarged view of an isolated crushed microballoon, which has been highlighted in FIG. 7b. It can be clearly seen from these figures that the initial softening response is due to the onset of crushing of microballoons. A good interfacial bonding between microballoons and matrix has produced clearly visible fragments of a crushed microballoon adhering to the surrounding matrix. This suggests that interfacial debonding between microballoons and matrix is not a major contributor in the observed global material response shown in FIG. 6. A bias in the direction of fractured microballoons at lower levels of deformation can be seen in FIG. 7a. With further deformation of the sample, microballoons fracture completely, leading to the densification response seen in the stress-strain curve. Failure of microballoons along inclined planes (relative to the loading direction) also indicates shear localization.

### IPC Foams

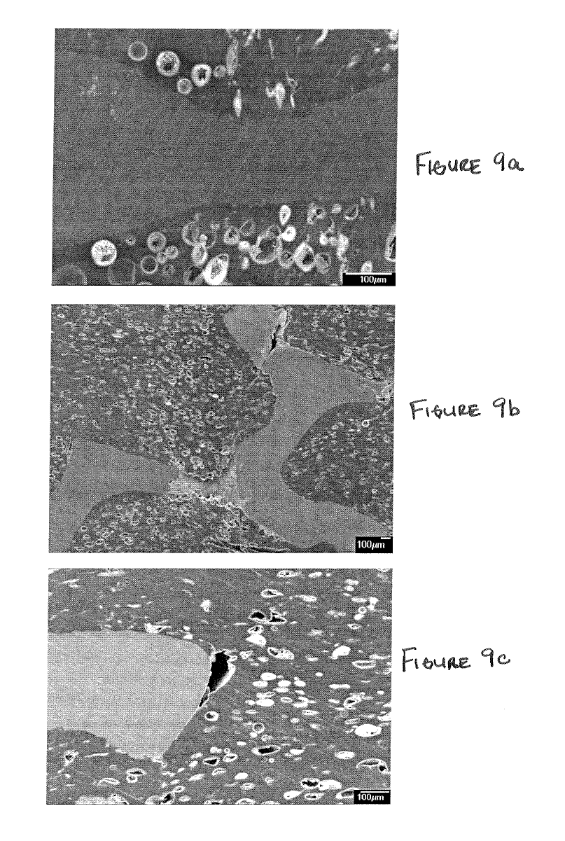

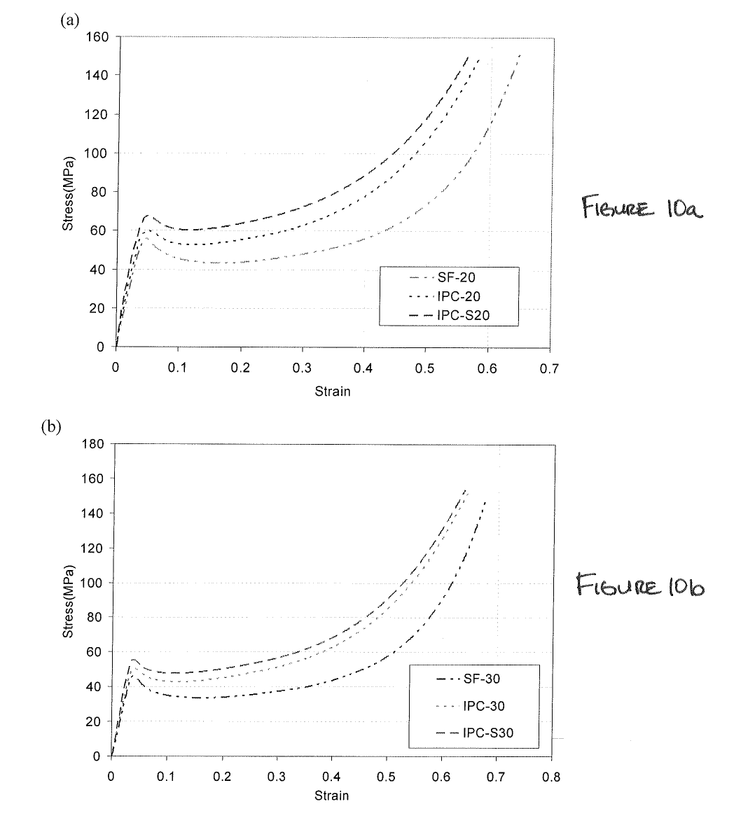

FIGS. 8a & 8b show typical stress-strain curves for different IPC foam samples. These plots correspond to samples made of aluminum preform infiltrated with syntactic foam containing 20%, 30% and 40% volume fractions of microballoons. FIG. 8a shows responses for IPC foam samples when the aluminum preform was used in ‘as-is’ (uncoated) conditions whereas plots in FIG. 8b are for IPC foam counterparts with silane treated preforms. (The inset in FIG. 8a corresponds to the compression response of un-infiltrated perform/scaffold. It is shown for comparative purposes and will be discussed below) In FIG. 8b three results for one particular type of IPC foam (20% syntactic foam with silane treated preform) are shown to demonstrate a high degree of repeatability of these tests. The overall response of IPC foam has similarities with the ones obtained for pure syntactic foam specimens (see FIG. 6). These plots depicted in FIGS. 8a & 8b also show three distinct regions typical of a foam behavior. Initially there is a linear elastic response. The stress plateau region following the onset of nonlinearity is characterized by progressive bending of aluminum ligaments of the IPC foam. This in turn results in crushing of microballons present in between the ligaments of aluminum preform. SEM images of silane coated IPC foam (with 30% volume fraction of microballoons and sample compressed in the horizontal direction) shown in FIGS. 9a, 9b & 9c support this observation. FIG. 9a is an image of silane coated IPC foam at a strain of 10% (compression horizontal); FIG. 9b is an image of silane coated IPC foam at a strain of 58% (compression vertical); and FIG. 9c is an image of uncoated IPC foam at a strain of 14% (compression vertical). With further increase in load the stress increases more rapidly (compared to syntactic foam samples as seen in FIG. 6). This can be explained by the micrograph in FIG. 9b where compaction of crushed microballoons and deformation of aluminum preform is clearly evident. The behavior is dependent on many factors among which the density (dependent on the volume fraction of the microballoons in the current IPC foam) of the composite generally being the most important. The SEM image in FIG. 9c clearly reveals the effect of weaker adhesion between the metal and polymer phases as evident from an isolated debond highlighted in the micrograph. Such debonds are generally absent even at relatively high strain levels when silane coated preform is used (see FIG. 9b).

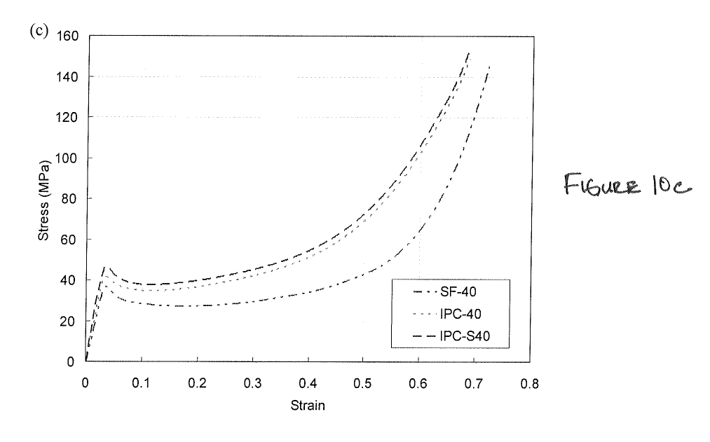

For comparison, the compression response of an unfilled aluminum preform is shown as an inset in FIG. 8a. It shows an elastic modulus of about 93 MPa and a plateau stress of about 2.5 MPa without any noticeable softening at the onset of cell collapse. This is unlike the response of typical syntactic foams (see FIG. 6) which have a noticeable softening at the onset of nonlinearity. When responses of pure syntactic and IPC foams with the same volume fraction of microballoons (FIGS. 10a, 10b & 10c) are compared, IPC foams show an increase in the plateau stress by as much as 15-20 MPa (depending upon the volume fraction of the microballoons in the infiltrated syntactic foam), much higher than that expected from the aluminum preform. FIGS. 10a, 10b & 10c depict a comparison of stress-strain response of syntactic foam, IPC foam with uncoated preform and IPC foam with silane coated preform for (10a) a 20% volume fraction, (10b) a 30% volume fraction, and (10c) a 40% volume fraction of microballoons. It has been discovered that synergistic mechanical constraint between aluminum ligaments of the preform and pockets of infused syntactic foam are responsible for this favorable response. That is, aluminum ligaments are laterally supported by the syntactic foam pockets preventing them from premature bending/buckling as in an unfilled preform. On the flip side, pockets of syntactic foam are reinforced by the metallic ligaments against an early collapse of microballoons.

Another comparison between the responses of IPC foam with silane coated and uncoated aluminum ligaments can be made from FIGS. 10a, 10b & 10c. The characteristics, such as yield stress, plateau stress and compaction response, seem to favor silane coated IPC foam over uncoated IPC foam and pure syntactic foam, in that order. This is largely attributed to the elimination of microscopic debonds between aluminum ligaments and syntactic foam as deformation progresses in case of coated IPC foam.

The elastic modulus of the composite was determined using the initial linear portion of the measured stress-strain curves. The elastic modulus and the upper yield stress for IPC foam made from uncoated and coated aluminum preforms are quantified in Table 3 and are found to monotonically decrease with increasing volume fraction of microballons in the syntactic foam:

TABLE 3
Properties of IPC Foam (20, 30, 40 designation denotes V_{f} of microballoons in the syntactic foam.)

| IPC foam with uncoated preform | | | | IPC foam with silane coated preform | | | |
|---|---|---|---|---|---|---|---|
| | | Compressive | Elastic | | | Compressive | Elastic |
| IPC | Density | Strength | Modulus | IPC | Density | Strength | Modulus |
| designation | (kg/m³) | (MPa) | (MPa) | designation | (kg/m³) | (MPa) | (MPa) |
| IPC-20 | 1008 ± 12 | 59.9 ± 2.5 | 1821 ± 17 | IPC-S20 | 1036 ± 13 | 67.5 ± 2.3 | 2123 ± 32 |
| IPC-30 | 937 ± 8 | 50.5 ± 1.8 | 1573 ± 12 | IPC-S30 | 954 ± 12 | 55.4 ± 3.6 | 1852 ± 27 |
| IPC-40 | 861 ± 12 | 41.5 ± 2.6 | 1442 ± 28 | IPC-S40 | 879 ± 18 | 45.8 ± 1.9 | 1702 ± 26 |

This behavior is consistent with the corresponding values of pure syntactic foam (see Table 2). From Table 3 it can also be noted that the elastic modulus and yield stress of IPC foam with silane coating is higher when compared with the corresponding uncoated preform for all volume fractions of microballoons in syntactic foam. As noted earlier, the increase in elastic modulus and compressive strength of silane coated preform can be attributed to improved wettability, which in turn enhances adhesion between the metal and polymer phases. The IPC foam is also found to have improved mechanical properties when compared with those for the respective syntactic foams.

In FIGS. 10a-10c, data for syntactic foam and the corresponding IPC foam samples with uncoated and silane coated preforms is examined comparatively for 20%, 30% and 40% volume fraction of microballoons. There is a substantial increase in all the relevant characteristics of IPC foam when compared to that for pure syntactic foam samples. The increase in elastic modulus for IPC foam with silane coated preform was found to be 33%, 28%, 35% for the composite IPC-S20, IPC-S30, IPC-S40, respectively when compared to the corresponding pure syntactic foam. (The corresponding increases can be assumed to be nearly constant after factoring experimental scatter in the data into account.) The relative increase in the compressive strengths for the three composites were 21.2%, 19.7%, 24.8%, respectively, relative to the corresponding syntactic foam samples. From FIGS. 10a-10c it can also be seen that treating aluminum preforms with silane results in an increase in plateau stress for the same three IPC foams when compared to the uncoated versions IPC-20, IPC-30 and IPC-40, respectively. Also the percentage increase is a maximum for IPC-S20 which is approximately 14% and it decreases with increasing volume fraction of microballoons to a value of about 8% for IPC-S40.

### Energy Absorption Properties

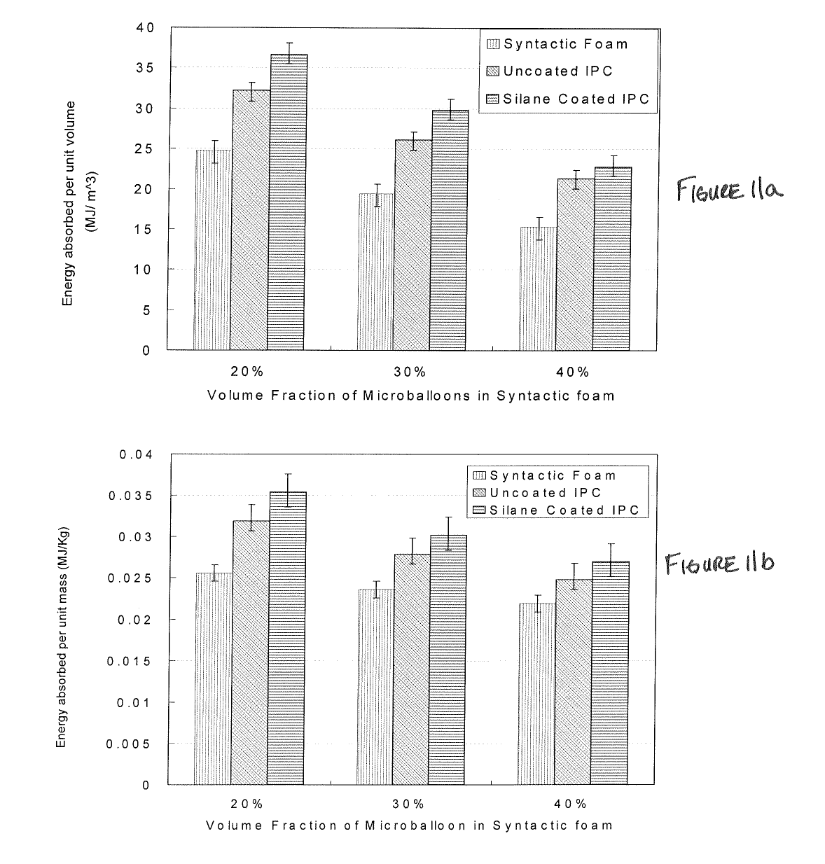

Conventional cellular materials have found application in automotive and packaging industries due to their excellent energy dissipation characteristics. The cellular structure of these materials enables them to undergo large deformations in compression, enabling them to absorb considerable amounts of energy. Thus, improvements in energy absorption achieved by IPC foam samples when compared to the corresponding syntactic foam counterparts need to be highlighted. The energy absorbed per unit volume (U) can be found by evaluating the area under the stress-strain curve

$$U = {\int }_{0}^{ɛ} σ ( ɛ ) d ɛ$$

where σ(∈) denotes uniaxial stress as a function of strain. The energy absorbed up to 50% strain are plotted as histograms in FIGS. 11a, 11b & 11c. The syntactic foam with 20% (SF-20) volume fraction of microballoons is found to have the highest value of energy absorption when compared to 30% (SF-30) and 40% (SF-40) cases, in that order. Similar trend can also be seen for IPC foam with silane coated and uncoated aluminum preform. Approximately 50% increase in the absorbed energy per unit volume of silane coated IPC foam samples relative to the conventional syntactic foam is evident from FIG. 11a.

Specifically, 48%, 53% and 49% increase in the absorbed energy per unit volume for IPC-S20, IPC-S30 and IPC-S40 relative to the conventional syntactic foam samples SF-20, SF-30 and SF-40, respectively, is indicative of the potential of IPC foams for energy dissipation applications. On the other hand, when IPC foam samples had an uncoated preform, the absorbed energy was modestly lower and was found to be 31%, 37%, 40% for IPC-20, IPC-30 and IPC-40 relative to SF-20, SF-30, and SF-40, respectively. Introduction of aluminum preform increases the overall weight of the composite and hence specific energy absorption (energy absorbed per unit mass) was also calculated. From FIG. 11b, it can be seen that the increase in the value of specific energy absorption per unit mass for IPC-S20 is found to be about 33% when compared to the corresponding syntactic foam case (SF-20). This value decreases to about 28% and 23% for IPC-S30 and IPC-S40 when compared to syntactic foam cases SF-30 and SF-40, respectively. This also shows that with increasing volume fraction of microballoons in syntactic foam, the percentage increase in the value of specific energy absorption reduces. From stress-strain plots shown in FIGS. 10a-10c for various volume fractions of microballoons in syntactic foam, it can be seen that coating the aluminum preform with silane results in improved compression characteristics of the IPC foam resulting in higher values of compressive strength and elastic modulus relative to the uncoated IPC foam. There is also an increase in energy absorption per unit mass of IPC foam with silane coated aluminum preform when compared to the uncoated preform and is found to vary between 11% and 9% with decreasing volume fraction of microballoons.

While the invention has been described with reference to preferred and example embodiments, it will be understood by those skilled in the art that a variety of modifications, additions and deletions are within the scope of the invention, as defined by the following claims.

What is claimed:

1. A method of producing a meso-/micro-scale Interpenetrating Phase Composite (IPC) foam, the method comprising:
a. preparing uncured epoxy-based syntactic foam; and
b. infiltrating the uncured syntactic foam into an open-cell metallic scaffold.

2. The method of claim 1, wherein the uncured epoxy-based syntactic foam contains premixed micron-size hollow glass microballoons.

3. The method of claim 2, wherein the microballoons have a mean diameter of about 50-70 micrometers and wall thickness of about 0.5-0.7 micrometers.

4. The method of claim 1, wherein the open-cell metallic scaffold is an aluminum scaffold.

5. The method of claim 1, wherein the scaffold contains millimeter size cavities.

6. The method of claim 5, wherein the scaffold has 30-50 pores per inch and about 8-10% relative density.

7. The method of claim 1, further including varying the volume fraction of microballoons in the syntactic foam from 10%-50% while keeping the volume fraction of the metallic scaffold the same to produce different IPC foam varieties.

8. A method of producing a meso-/micro-scale Interpenetrating Phase Composite (IPC) foam, the method comprising:
a. preparing uncured epoxy-based syntactic foam;
b. coating an open-cell metallic scaffold with silane to increase adhesion between the metallic scaffold and polymer foam; and
c. infiltrating the uncured syntactic foam into the metallic scaffold.

9. The method of claim 8, wherein the uncured epoxy-based syntactic foam contains premixed micron-size hollow glass microballoons.

10. The method of claim 9, wherein the microballoons have a mean diameter of about 50-70 micrometers and wall thickness of about 0.5-0.7 micrometers.

11. The method of claim 8, wherein the open-cell metallic scaffold is an aluminum scaffold.

12. The method of claim 8, wherein the scaffold contains millimeter size cavities.

13. The method of claim 12, wherein the scaffold has 30-50 pores per inch and about 8-10% relative density.

14. The method of claim 8, wherein the silane used is an amino silane.

15. The method of claim 8, further including varying the volume fraction of microballoons in the syntactic foam from 10%-50% while keeping the volume fraction of the metallic scaffold the same to produce different IPC foam varieties.

16. A method of producing a meso-/micro-scale Interpenetrating Phase Composite (IPC) foam, the method comprising:
a. preparing uncured epoxy-based syntactic foam; and
b. infiltrating an open-cell metallic scaffold into the uncured syntactic foam.

17. The method of claim 16, wherein the uncured epoxy-based syntactic foam contains premixed micron-size hollow glass microballoons.

18. The method of claim 16, wherein the microballoons have a mean diameter of about 50-70 micrometers and wall thickness of about 0.5-0.7 micrometers.

19. The method of claim 16, wherein the open-cell metallic scaffold is an aluminum scaffold.

20. The method of claim 16, wherein the scaffold contains millimeter size cavities.

21. The method of claim 20, wherein the scaffold has 30-50 pores per inch and about 8-10% relative density.

22. The method of claim 16, further including varying the volume fraction of microballoons in the syntactic foam from 10%-50% while keeping the volume fraction of the metallic scaffold the same to produce different IPC foam varieties.

23. The method of claim 16, further including coating the metallic scaffold with silane.

24. The method of claim 23, wherein the silane used is an amino silane.

25. A composition of an Interpenetrating Phase Composite foam, the composition comprising:
a. a metallic scaffold; and
b. uncured epoxy-based syntactic foam containing premixed micron-size hollow glass microballoons.

26. The composition of claim 25, wherein the metallic scaffold is an aluminum scaffold.

27. The composition of claim 25, wherein the metallic scaffold contains millimeter size cavities to accommodate the microballoons.

28. The composition of claim 25, wherein the microballoons have a mean diameter of about 50-70 micrometers and wall thickness of about 0.5-0.7 micrometers.

29. The composition of claim 25, wherein the metallic scaffold is coated with silane.

30. The composition of claim 29, wherein the silane used is an amino silane.

31. A product produced by the method of claim 1.

32. A product produced by the method of claim 6.

33. An Interpenetrating Phase Composite foam (IPC) produced by the method comprising:
a. providing an uncured epoxy-based syntactic foam;
b. infiltrating the uncured epoxy-based syntactic foam into an open-cell metallic scaffold;
c. curing the uncured epoxy-based syntactic foam to produce the Interpenetrating Phase Composite foam.

34. An Interpenetrating Phase Composite comprising:
a. a metallic scaffold; and
b. a cured epoxy-based syntactic foam in contact with the scaffold.

35. A method for making an Interpenetrating Phase Composite (IPC), the method comprising:
a. providing an uncured epoxy-based syntactic foam;
b. infiltrating the uncured epoxy-based syntactic foam into an open-cell metallic scaffold;
c. curing the uncured epoxy-based syntactic foam to produce the Interpenetrating Phase Composite.
